(19) United States
(12) Patent Application Publication
(10) Pub. No.: US 2022/0148414 A1
(43) Pub. Date: May 12, 2022

(54) COVERT PERSONAL SAFETY DEVICE AND SYSTEM

(71) Applicant: Stephen Mruk, Barnegat, NJ (US)

(72) Inventor: Stephen Mruk, Barnegat, NJ (US)

(21) Appl. No.: 17/518,096

(22) Filed: Nov. 3, 2021

Related U.S. Application Data
(60) Provisional application No. 63/110,805, filed on Nov. 6, 2020.

(51) Int. Cl. G08B 25/01; G08B 25/12; H04W 4/90

(52) U.S. Cl. CPC G08B 25/016; H04W 4/90; G08B 25/12

(57) ABSTRACT

In one implementation, there is a personal safety device and system that permits for an inconspicuously worn device to be discreetly triggered to alert a third party of a threat to the wearer's personal safety. In at least one implementation, the personal safety device takes the form of a piece of jewelry (e.g. bracelet, necklace, etc.) that sends a wireless signal to a host device once a portion of the piece of jewelry is separated from the rest of the jewelry component. The alert may be forwarded to emergency services thereby allowing them to respond to the wearer's location.

### CLAIM OF PRIORITY

This application is a non-provisional application which claims priority to U.S. Provisional Application Ser. 63/110,805 filed Nov. 6, 2020, the disclosure of which is hereby incorporated.

### FIELD OF THE EMBODIMENTS

The field of the invention and its embodiments relate to a covert personal safety device and system that may interface with a host device and alert the host device or other secondary device/personnel of a threat to one's personal safety. In particular, the present invention and its embodiments permit for an inconspicuously worn device that may be discreetly triggered to alert a third party of a threat to the wearer's personal safety.

### BACKGROUND OF THE EMBODIMENTS

The present invention and its embodiments are directed to covert personal safety devices and systems where a user can easily contact a third party (e.g. emergency services, family member, etc.) in the event of a disabling medical injury, a threat to their personal safety, or similar event requiring third party intervention. The present disclosure is directed to a device worn on a user's body that is configured to interact directly with a host or other paired device, such as a smart phone or the like, to facilitate contact with a third party from nearly any location in which the wearer is located.

Known personal alert systems generally consist of multiple components that do not easily lend themselves to be worn and triggered discreetly. Most often, these devices comprise a device to be carried around by the user, which works in conjunction with a base unit connected to a land line phone system or a communication device via a wireless means. In such implementations, these devices/systems are limited in operation to only those times when the user device is within a certain distance of the base unit or requires dedicated transmitters, receivers, etc. Further, these systems require the user to take the affirmative action of pressing an “alert button” thereby signifying to those around them that the device has been activated.

Accordingly, there is a need for a wireless personal safety device and system that is discreetly worn and more importantly easily and discreetly to trigger. In addition, there is a need for a personal safety device/system that is worn by its user rather than having to be carried in a secondary item such as a purse or clutch. The present invention and its embodiments address these needs and provides other related advantages.

### Review of Related Technology:

U.S. Pat. No. 9,412,249 pertains to a variety of styles and designs of ornamental enclosures and/or attachments and distinguished by being constructed with one or more of the following products: durable metals, alloys, plastics, composites, ceramics, enamels, similar materials or other durable products or combinations thereof which may be adorned with precious, semiprecious or costume jewels or other decorations and considered as jewelry and will be adapted to enhance the appearance of monitored common emergency alert devices. A free-floating actuator button in the jewelry would be depressed over a common emergency alert device button summoning assistance. Another embodiment of Lovely Life Jewelry could be made with generic internal emergency alert circuitry to connect with existing or future emergency alert services. The purpose of the designer or costume jewelry is to make emergency alert devices more attractive and, therefore, enhance the health, safety, and security of the wearer.

U.S. Pat. No. 8,957,774 pertains to a transmitter, GPS, clock and, optionally, a microphone, video camera and identification signal means, and health monitoring sensors are housed in personal articles such as a pendant, a watch, a ring, mobile telephone, or other personal article. The article is disguised to look like it does not have all or some of said features, and is provided with a switching device, preferably operable with one hand, to turn the transmitter on.

Preferably, the switching device has two switching elements which require simultaneous operation to energize the transmitter, to minimize false alarms. The method of use includes selecting the best-suited type of transmitter, causing emergency personnel to be prepared to act when receiving transmission from the alarm device, and advising users on carrying the modified personal article when protection is desired.

U.S. Patent Application Publication 2014/0378089 pertains to a wireless mobile emergency system that includes a mobile user device, a cellular phone, and a communication network. The mobile user device and cellular phone are wirelessly connected through radio frequency, Wi-Fi, or Bluetooth systems. The cellular phone is connected to a communication network such as a cellular or Wi-Fi network. Depressing a button on the mobile user device activates the cell phone to automatically call preprogrammed numbers, i.e., emergency services, non-emergency services, family members. Preferably, the device is programmed to bypass password protection or other security features on the cell phone.

Various systems and methods exist for protecting one's self from harm and alerting others to the same. However, their structure and method of use is substantially different from the present disclosure, as the other inventions fail to solve all the problems taught by the present disclosure.

### SUMMARY OF THE EMBODIMENTS

The present invention and its embodiments relate to a discreet and covert personal safety device that may also be triggered discreetly by a user. In at least one embodiment, the personal safety device takes the form of a traditional piece of jewelry such as a necklace or bracelet. Once the device is triggered (e.g. a trigger mechanism is separated from the rest of the device), a wireless signal is sent to an electronic device that is paired or otherwise communicatively coupled to the personal safety device.

The wireless signal may contain various information including but not limited to a unique identifier associated with the personal safety device. This identifier allows for identification of the device associated with it and, in some instances, may identify the type of threat based on a culmination of factors that cause the device to send the wireless signal.

The electronic device to which the signal is sent may be any number of compatible electronic devices (smart phones, smart watches, gaming devices, laptop computers, desktop computers, head mounted displays, etc.) and the signal may be associated with contacting local law enforcement, activating a local alarm, and/or calling a predetermined phone number and delivering an automated message. The electronic device should be able to, at minimum, discern the time/date of the activation of the signal as well as a location of the personal safety device such that the wearer can be attended to, as necessary.

In a first embodiment of the present invention there is a personal safety device having a housing with a wireless communication device coupled thereto; a non-triggering portion coupled to the housing; and a trigger portion coupled to the housing, wherein when the trigger portion is separable from the housing.

In another embodiment of the present invention there is a personal safety device having a metallic housing with a wireless transceiver coupled thereto; a non-triggering portion permanently coupled to the housing; and a trigger portion removably coupled to the housing; wherein the wireless transceiver is configured to broadcast an identifier associated with the personal safety device when the trigger portion is decoupled from the housing, and wherein the identifier is broadcast to a wireless device.

In yet another embodiment of the present invention there is a personal safety system having a personal safety device comprising: a metallic housing having a wireless transceiver coupled thereto, a non-triggering portion permanently coupled to the housing, and a trigger portion removably coupled to the housing, wherein the wireless transceiver is configured to broadcast an identifier associated with the personal safety device when the trigger portion is decoupled from the housing, and wherein the identifier is broadcast to a wireless device; and an electronic device coupled to the wireless transceiver of the personal safety device, the electronic device configured to receive a broadcast message containing an identifier from the personal safety device.

In general, the present invention succeeds in conferring the following benefits and objectives.

It is an object of the present invention to provide a personal safety device that is worn discreetly.

It is an object of the present invention to provide a personal safety device that is capable of being activated discreetly.

It is an object of the present invention to provide a personal safety device that is lightweight and comfortable to wear.

It is an object of the present invention to provide a personal safety device that is fashionable.

It is an object of the present invention to provide a personal safety device that is capable of alerting third parties to a threat to a wearer's safety or other status requiring third party intervention.

It is an object of the present invention to provide a personal safety device that allows a location of an alert signal to be determined.

It is an object of the present invention to provide a personal safety device that prevents and/or limits theft of the device from a person's body.

### BRIEF DESCRIPTION OF THE DRAWINGS

FIG. 1 a first perspective view of an embodiment of the personal safety device showing a non-triggering portion being attached.

FIG. 2 is a second perspective view of an embodiment of the personal safety device showing a trigger portion being attached.

FIG. 3 is a third perspective view of an embodiment of the personal safety device showing a trigger portion being attached.

FIG. 4 is a front view of an embodiment of the personal safety device fully assembled.

FIG. 5 is a sectional side view of an embodiment of the present invention showing an attachment of the trigger portion with a housing of an embodiment of the present invention.

FIG. 6 is a flow chart illustrating a method of use of an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

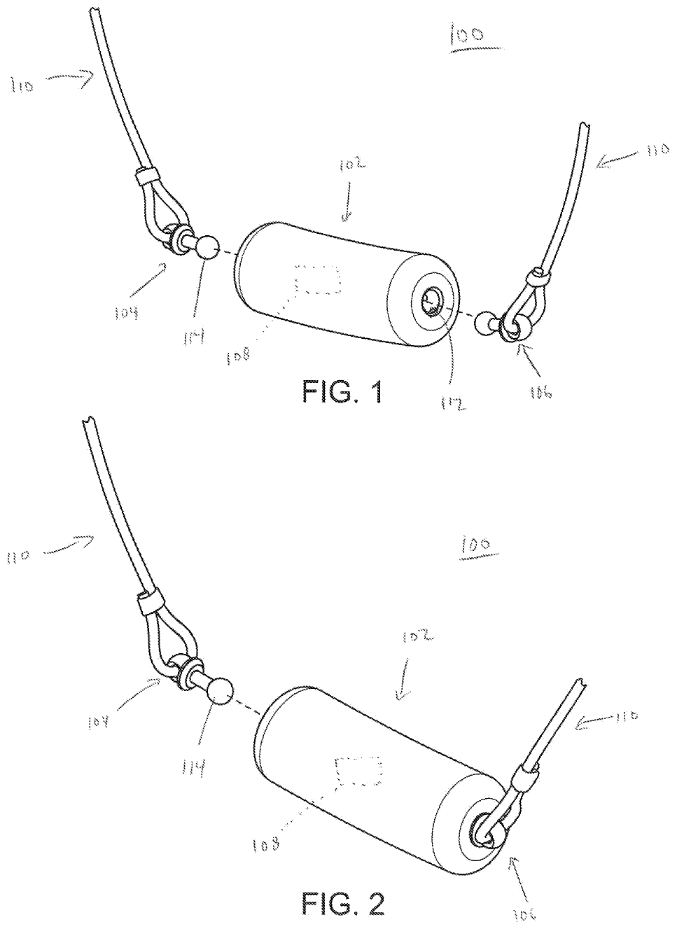

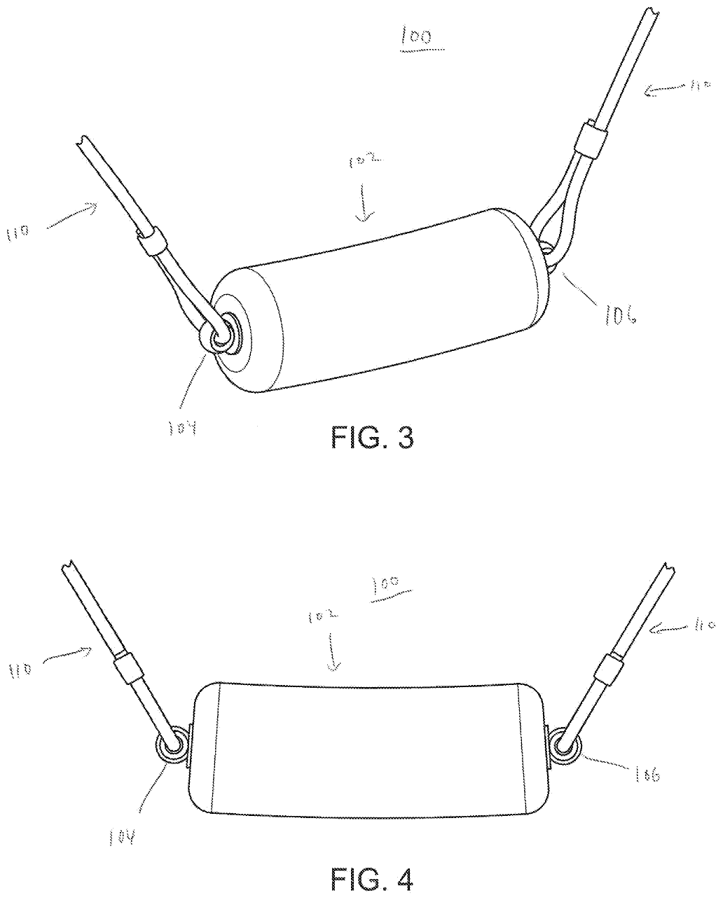

Referring now to FIGS. 1-4, there is an embodiment of the present invention generally comprising a housing 102, a wireless communication device 108, a trigger portion 104, a non-trigger portion 106, straps 110, recess 112, and attachment mechanism or ball member 114.

Generally, the device 100 is embodied as a personal safety device functioning as a covert remote triggering device configured to interface and communicate wirelessly with electronic device(s). The device 100 bears a reduced profile that enables a user to inconspicuously wear the device 100 without calling attention to the device 100 or the manner in which the device 100 is to be activated. In use, the device 100 functions as an extension of one's personal security, providing a way to alert, a third party, locally and/or remotely, during a personal attack or other emergency.

In at least one embodiment, the device 100 is designed to be seamlessly integrated into a piece of jewelry to be worn by a user. The piece of jewelry may be virtually any piece of jewelry in which at least one piece or portion of the jewelry is separable from the remainder of the piece of jewelry. In other embodiments, the device 100 may be built into other accessories typically worn on a person or routinely kept within one's proximity (e.g. handbags, wallets, sunglasses, etc.)

When embodied has a piece of jewelry, the device 100 may have straps 110 (chain, etc.) that assist to affix the jewelry to the user. The straps 110 may be comprised of most materials and including precious metals, metals, polymers, composites, textiles, and the like or some combination thereof. The material and the manner in which the material is formed into the straps 110 is to be selected such that the straps 110 are to have a tensile strength that is greater than the force required to activate the trigger portion 104. This allows for the trigger portion 104 to be activated without strap 110 failure, as strap 110 failure may cause the trigger portion 104 to not activate.

The straps 110 may further be a continuous strap or multiple straps or segments of straps that ultimately form the straps 110. At a first end and a second end of the straps 110 there is a trigger portion 104 and a non-trigger portion 106. The trigger portion 104 and the non-trigger portion 106 can be on either end of the straps 110 as long as the trigger portion 104 and the non-trigger portion 106 are on opposing ends of the strap 110.

The trigger portion 104 and the non-trigger portion 106 may be the same or different in terms of construct as one another. In at least one embodiment, the non-trigger portion 106 is permanently fused to the housing 102 of the device 100. In such an instance, the non-trigger portion 106 may be made of the same material as the housing 102 and is simply an extension of the housing 102 configured to mimic the trigger portion 104. Thus, the non-trigger portion 106 would contain an identical outward appearance as to that of the trigger portion 104 once the trigger portion 104 is coupled to the housing 102. In yet another embodiment, the trigger portion 104 and the non-trigger portion 106 bear identical structure and interact with the housing 102 in the same fashion. However, as will be further described, the non-trigger portion 106 may require a considerably larger force to remove it from the housing 102 to ensure the trigger portion 104 is the first portion to be removed from the housing 102 in the event of activation of the device 102. In at least one embodiment, the force by which either portion (trigger or non-trigger) is user configurable. That is, the user may manipulate the device 100 to create custom force threshold(s).

The trigger portion 104 and/or non-trigger portion 106 comprise a section configured to be coupled to the straps 110 as well as a portion configured to be coupled to the housing such as a ball member 114. The exact shape and size of the ball member 114 may be varied under the purview of this application. For example, the ball member 114 is cube shaped as opposed to ball shaped and interacts with the housing 102 in a manner as the ball shape would. In yet other embodiments, the trigger portion 104 or a portion thereof comprises magnetic properties. This allows the housing 102 and trigger portion 104 to act as a reed switch that is activated upon removal of the trigger portion 104 from the housing 102.

In at least one embodiment, there is only a trigger portion 104 and no non-trigger portion 106 exists. Such an embodiment may take the form of a pendent with a single attachment point. In yet other embodiments, there is a pending or the like that has both a trigger portion 104 and a non-trigger portion 106. In such an embodiment, the two attachment points may be distinct or may overlap such that the non-trigger portion 106 is not readily visible to a third party when the device 100 is worn by a user.

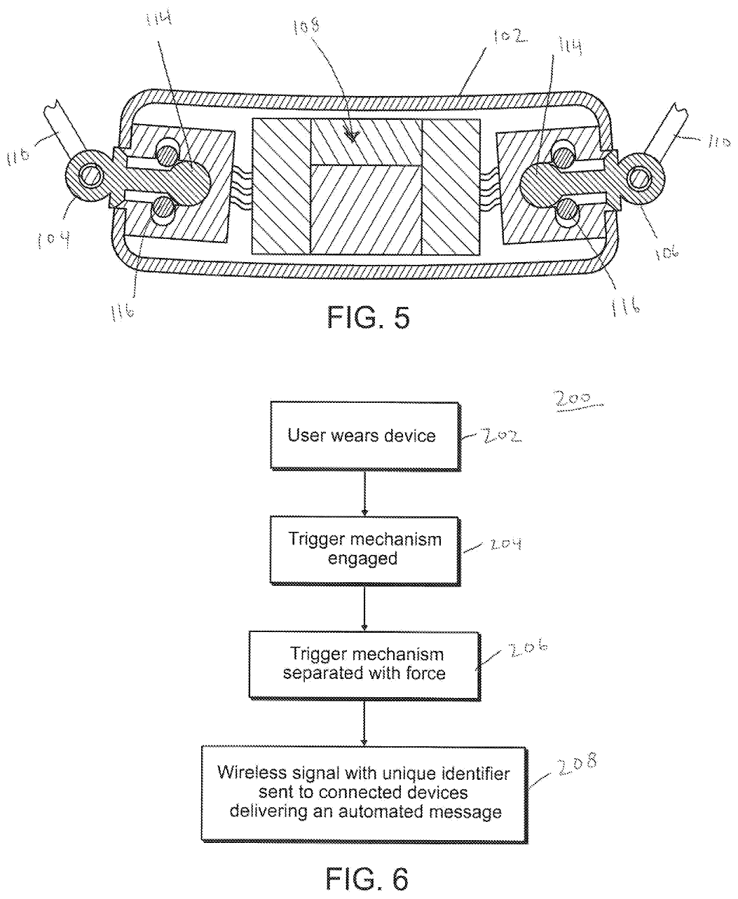

The housing 102 is configured to receive at least one of the trigger portion 104 and/or the non-trigger portion 106 (depending on whether non-trigger portion is removable). The housing 102 may have a recess 112 located at each a first end and a second end of the housing. The recess 112 may have a shape and depth to receive and retain the ball member 114. The housing 102 may be configured and positioned to sit on the back of the neck or along the wrist and mimic a small jewelry clasp as to be inconspicuous. The housing 102 may bear a slight slight curvature to an outer surface of the housing 102 thereby making the housing 102 more functional and aesthetically pleasing to the user. The housing 102 may comprise a metal or metal coated polymers to provide an overall metallic appearance and to match existing jewelry in the event the housing is retrofit into a user's existing jewelry piece. In at least one embodiment, a combination of metal and insulating polymers may enable the housing 102 to act as an antenna for the device 100, thereby increasing the broadcast range of the signal generated by the wireless communication device 108. The housing 102 may further contain or house a trigger switch mechanism, power source, antenna, and varying combinations thereof (see FIG. 5).

The wireless communication device 108 may be a wireless transceiver device, and more specifically may be a low power Bluetooth® module. Such a wireless communication device 108 is preferably configured to communicate with a host device, which may be virtually any electronic device such as a laptop computer, desktop computer, smart watch, gaming system, head worn display, a cellular telephone, or tablet or some combination thereof. Upon activation of the trigger portion 104, the wireless communication device 108 will be powered by the power source causing the wireless communication device to broadcast a unique identifier and/or other information to the host device. In at least one embodiment, any number of electronic devices may be able to receive the unique identifier broadcast and be configured to further transmit the same message. This will largely increase the effective range and use of the device 100 making up for any shortcomings in the broadcast distance of the wireless communication device 108.

Referring now to FIG. 5, the device 100 is shown from a sectional side view showing a representation of the internals of the device 100. Included in the device 100 may be a trigger mechanism 116, a power source (not shown), antenna (not shown), wireless communication device 108, PCB (not shown), and wiring. The device 100 is preferably in as small a form factor as the technology enables thereby lending itself to the inconspicuous nature of the device 100. For example, the device dimensions may be approximately 1 inch to 1½ inches in length by ¼ inch to ½ inch in width. Other dimensions may be necessary depending on the materials used and the components included with the device 100.

As shown in this embodiment, the device 100 is designed to be connected between, or alternatively replace, the clasps or closure mechanism of existing piece jewelry or another known device. In at least one embodiment, the device 100 has multiple clasp options to enable attachment of the various existing clasp or closure designs. The trigger portion 104 connects to the housing 102 via a recess 112 (see FIG. 1) that functions as an electrical switch. The device 100 is activated or triggered when sufficient force removes the triggering portion 104 (and by extension ball member 114) from the recess 112. A retainment member 116 may further interact with the ball member 114 to retain the ball member 114 within the recess 112. In at least one embodiment, the force required to pull the trigger portion 104 from the recess 112 may be set with sufficient force to keep the trigger portion 104 in place when exposed to normal wear and tear conditions, but not so high as to allow the straps 110 to break. This enables the user to quickly and discreetly pull the device 100 off their body, thereby activating the device 100 and subsequently activating the host or other device to alert a user associated with that device as to the threat to the user's security. In order to remove the device 100 under normal circumstances, the user would use the non-trigger portion 106 of the device 100 or an alternate closure mechanism (i.e. removing the strap from the trigger or non-trigger portion).

Referring now to FIG. 6, there is a flow chart outlining a preferred method 200 of use of the present application. In at least one embodiment, the device will be paired with software designed to run on most cellular mobile devices or other electronic devices. Initial setup of the software may be accomplished by various methods dependent on the user's intended use. The software and electronic device may initially pair with the device by an initial activation of the transceiver using the trigger portion. Upon the initial activation the software captures the identifier assigned to the device and pairs it to the host and the user's account. Upon successful pairing, the device is de-activated by re-inserting the trigger portion into the recess. From this point forward, if the device is activated it will wirelessly trigger an alert to the software and alert any number of third parties or take other actions which may include but are not limited to sending a panic signal and location information to law enforcement, calling a predetermined number with a message, or activating a local alarm signal. Once the setup has been completed, the user can wear the device 202. In step 204, the trigger portion has been engaged and the device is in an inactive or hibernation state. In step 206, the trigger portion is separated from the device thereby causing the wireless communication device to broadcast a signal containing an identifier. This wireless signal is then received by connected devices, as shown in step 208, such that appropriate action can then be taken.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A personal safety device comprising:
a housing having a wireless communication device coupled thereto;
a non-triggering portion coupled to the housing; and
a trigger portion coupled to the housing,
wherein when the trigger portion is separable from the housing.

2. The device of claim 1 wherein the wireless communication device is a wireless transceiver.

3. The device of claim 1 wherein the trigger portion is a clasp structure.

4. The device of claim 1 wherein the trigger portion is a ball structure.

5. The device of claim 1 wherein the wireless communication device is configured to broadcast an identifier associated with the personal safety device.

6. The device of claim 1 wherein the housing is comprised of metal.

7. The device of claim 1 wherein the housing is comprised of a metal coated polymer.

8. The device of claim 5 wherein the identifier is broadcast when the trigger portion is decoupled from the housing.

9. The device of claim 1 wherein the non-triggering portion is not removable from the housing.

10. A personal safety device comprising:
a metallic housing having a wireless transceiver coupled thereto;
a non-triggering portion permanently coupled to the housing; and
a trigger portion removably coupled to the housing;
wherein the wireless transceiver is configured to broadcast an identifier associated with the personal safety device when the trigger portion is decoupled from the housing, and
wherein the identifier is broadcast to a wireless device.

11. The device of claim 10 wherein the metallic housing has a recess configured to receive the trigger portion.

12. The device of claim 10 wherein when the trigger portion and the housing are coupled, a switch is held in a monitor state.

13. The device of claim 10 wherein when the trigger portion and the housing are decoupled, a switch is held in an alert state.

14. The device of claim 10 wherein a force required to decouple the trigger portion from the housing is selectable.

15. The device of claim 10 wherein the identifier is broadcast to emergency services.

16. A personal safety system comprising:
a personal safety device comprising:
a metallic housing having a wireless transceiver coupled thereto,
a non-triggering portion permanently coupled to the housing, and
a trigger portion removably coupled to the housing,
wherein the wireless transceiver is configured to broadcast an identifier associated with the personal safety device when the trigger portion is decoupled from the housing, and
wherein the identifier is broadcast to a wireless device; and
an electronic device coupled to the wireless transceiver of the personal safety device, the electronic device configured to receive a broadcast message containing an identifier from the personal safety device.

17. The system of claim 16 wherein the non-triggering portion and the trigger portion are coupled to opposing ends of the metallic housing.

18. The system of claim 16 wherein the metallic housing is configured to act as an antenna for the wireless transceiver.

19. The system of claim 16 wherein the metallic housing and trigger portion are coupled via a ball and socket mechanism.

20. The system of claim 16 wherein the electronic device is preprogrammed to carry out an action once the identifier is received by the electronic device.
